(19) United States
(12) Patent Application Publication
(10) Pub. No.: US 2013/0191305 A1
(43) Pub. Date: Jul. 25, 2013

(54) APPARATUS FOR VALIDATING PROCESSES FOR INFORMATION COMPLETENESS

(71) Applicants: Amanda E. Chessell, Alton (GB); Kamorudeen L. Yusuf, Eastleigh (GB)

(72) Inventors: Amanda E. Chessell, Alton (GB); Kamorudeen L. Yusuf, Eastleigh (GB)

(73) Assignee: International Business Machines Corporation, Armonk, NY (US)

(21) Appl. No.: 13/356,571

(22) Filed: Jan. 23, 2012

(51) Int. Cl. G06Q 10/00

(52) U.S. Cl. 705/348

(57) ABSTRACT

Embodiments of the present invention provide a method, system and computer program product for modeling and validating a user process. In an embodiment of the invention, a model validation method can include linking in memory of a computer a task of an activity modeled within a business process model to a defined role specifying information accessible to end users associated with the defined role and additionally linking in the memory of the computer the task of the activity to an object model specifying information required by an end user to complete a corresponding task. The method also can include generating a mapping from the linkings. Finally, the method an include validating the business process by determining from the mapping whether or not an end user associated with the role can access information necessary to perform the task.

### BACKGROUND OF THE INVENTION

1. Field of the Invention

The present invention relates to process modeling and more particularly process modeling in which information is shared between multiple process and applications, and in which the modeled process forms a small part of the role of a user.

2. Description of the Related Art

Key performance indicators (PKIs) are the detailed specifications used to track business objectives. A KPI is associated with a specific process and is generally represented by a numeric value; it can be thought of as a metric with a target. For instance, a simple KPI can be: Average time for response to a customer inquiry is less than two days. Existing organizations and process modeling software tools provide ways of simulating a process to determine if the process can meet the required KPIs. In this regard, process modeling tools provide a means for simulating a defined process to determine if it can operate within certain business parameters so as to meet the required KPIs. These simulations are based on metrics (cost-based, time-based), however, these simulations but do not provide insight into the information needed to complete the process.

Organizations generally use processes to control when certain work is done and when decisions are made for a variety of different reasons, including to maintain a competitive advantage, to satisfy legislative requirements, and to predict and control business performance. These processes can be modeled with a modeling language modeling tool, an example of which includes a unified modeling language (UML) modeling tool. A modeling tool is a software application that supports the notation and semantics associated with a modeling language like UML.

Generating a model for an organizational process is not a self-contained exercise. Rather, once a model has been generated, model verification and also model validation is required. Model verification and validation are essential parts of the model development process if models to be accepted and used to support decision making. Verification is done to ensure that the model is programmed correctly, that the algorithms have been implemented properly, and that the model does not contain errors, oversights, or bugs. Thus, verification ensures that the specification is complete and that mistakes have not been made in implementing the model. Validation by comparison, ensures that the model meets its intended requirements in terms of the methods employed and the results obtained. The ultimate goal of model validation is to make the model useful in the sense that the model addresses the right problem, provides accurate information about the system being modeled, and to makes the model actually used.

### BRIEF SUMMARY OF THE INVENTION

Embodiments of the present invention address deficiencies of the art in respect to user processes and provide a novel and non-obvious method, system and computer program product for modeling and validating a user process. In an embodiment of the invention, a model validation method can include linking in memory of a computer a task of an activity modeled within a business process model to a defined role specifying information accessible to end users associated with the defined role and additionally linking in the memory of the computer the task of the activity to an object model specifying information required by an end user to complete a corresponding task. The method also can include generating a mapping from the linkings. Finally, the method an include validating the business process by determining from the mapping whether or not an end user associated with the role can access information necessary to perform the task.

In one aspect of the embodiment, the role additionally can specify tasks able to be performed by an associated end user and therefore, the validating further can include determining from the mapping whether or not an end user associated with the role is able to perform the task of the activity. In another aspect of the embodiment, an alert can be generated in a display of the computer responsive to a failure when validating the business process. In yet another aspect of the embodiment, the method can further include re-assigning a different user associated with a different role to perform the activity in response to a failure when validating the business process.

In another embodiment of the invention, a business process modeling and validation data processing system can be provided. The system can include a computer with at least one processor and memory coupled to a data store of business process models. The system also can include a modeling tool executing in the memory of the computer. Finally, the system can include a validation module. The module can include program code enabled upon execution in the memory of the computer to link in the memory of the computer a task of an activity modeled within a business process model in the data store to a defined role specifying information accessible to end users associated with the defined role, to additionally link in the memory of the computer the task of the activity to an object model specifying information required by an end user to complete a corresponding task, to generate a mapping from the linkings, and to validate the business process by determining from the mapping whether or not an end user associated with the role can access information necessary to perform the task.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for modeling and validating a user process to ensure the process has the information required to complete the task;

FIG. 2 is a schematic illustration of a modeling and validation system; and,

FIG. 3 is a flow chart illustrating a process for modeling and validating a user process to ensure the process has the information required to complete a task.

### DETAILED DESCRIPTION OF THE INVENTION

Embodiments of the invention provide for model validation in a computer system. In accordance with an embodiment of the invention, a process model can be generated for an organizational process in a modeling tool. The process model can include one or more activities, and one or more roles for end users participating in the activities. The roles each can be defined to specify those tasks able to be performed by a user of a corresponding role, along with information objects necessary to perform those tasks and goals to be achieved according to those tasks by an end user corresponding to the role. Also, the process model can include one or more object models. Each object model can specify one or more tasks and the objects required to complete those tasks.

Links can be recorded between one or more of the roles and one or more corresponding activities so as to model the performance of the activity by an end user corresponding to a linked role. Links also can be recorded between one or more tasks and one or more of the object models. Thereafter, the process model can be validated by determining whether or not an end user of a role linked to an activity enjoys access to those objects requisite to completing the tasks of an object model linked to the activity, and whether or not an activity linked to an end user is appropriate for that end user according to the role. In this way, the process model is validated to ensure that each end user possesses the requisite information to complete a corresponding task of an activity, and that the end user has been appropriately assigned to the task in the first instance based upon the role of the end user and the requirements of the task.

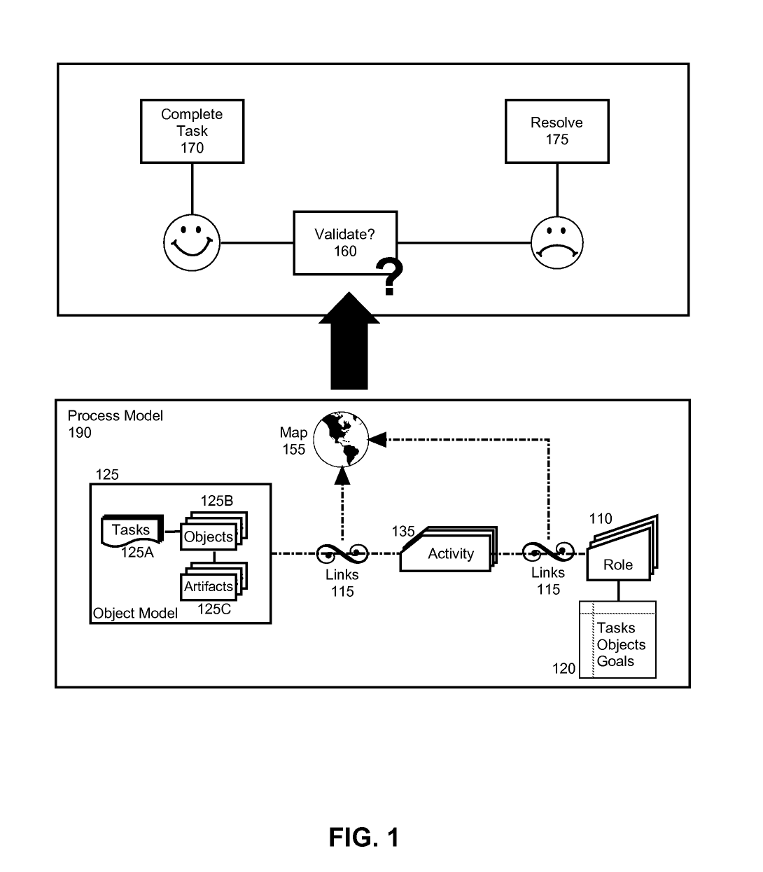

In further illustration, FIG. 1 pictorially shows a user process for modeling and validating a user process to ensure the process has the information required to complete the task. As shown in FIG. 1, a process model 190 can be defined to bridge a user model 110 with the process model 190 via an object model 125. An object model 125 can be used to model the characteristics of computer software and the interactions with a user that are required to operate the software. The object model 125 shows the tasks 125A a user must perform, the objects 125B a user is to working with in order to perform the tasks 125A, and artifacts 125C which are physical manifestations of the objects 125B. The object model 125 can be linked 115 to different activities 135 defined for the process model 190.

Of note, links 115 can be created from role 110 to activity 135, including an inferred link to a goal 120, and from task 125A to activity 135. In this way, the role 110 of an end user can be assigned to perform the linked activity 135 which then can be subjected to validation 160 against the object model 125 in order to ensure that the end user associated with the linked role 110 enjoys access to the objects 125B and artifacts 125C necessary to perform the tasks 125A linked to the activity 135. To the extent the links 115 in the mapping 155 do not provide such an outcome, validation 160 will fail requiring resolution 175, and a notification can be provided to modify the process model 190 to either assign a different one of the roles 110 to the activity 135, or to adapt the objects 125B in the process model 190. Otherwise, validation will have succeeded 170.

Notably, an information anomaly resulting from a failure during validation 160 of a role 110 assigned to an activity 135 linked to a corresponding object model 120 in the mapping 155 can be resolved in a number of different ways, including but not limited to creating a team (a collection of roles that have the expertise and knowledge to complete work) and assigning the activity 135 to the team in the form of a sub-process, redesigning the role 110 assigned to the activity 135 to ensure access to the requisite information to complete the tasks 125A of the linked object model 125, or redesigning the process model 190 set of activities 135 by re-sequencing the activities 135 to allow for the acquisition of the requisite objects 135 of the linked object model 125 prior to performing the activity 135 of interest.

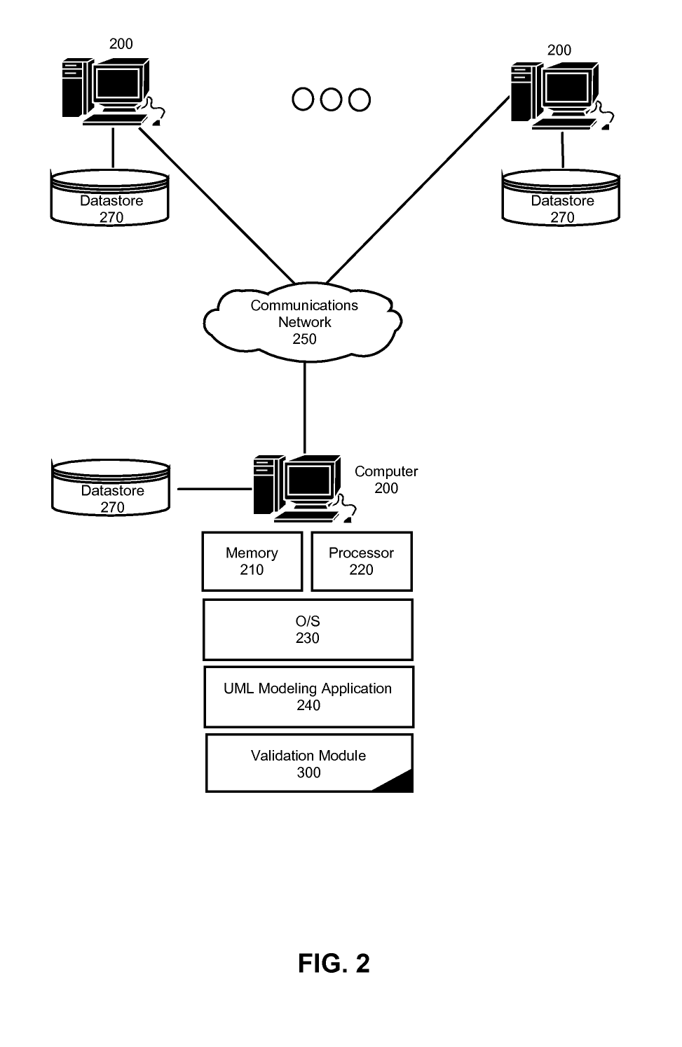

The process described in connection with FIG. 1 can be implemented in a modeling and validation data processing system. In further illustration, FIG. 2 is a schematic illustration of a modeling and validation system data processing system. The system can include a computer 200 that in turn includes at least one processor 220 and memory 210 supporting the execution of an operating system (O/S) 230. The O/S can in turn support a modeling application 240 coupled to a modeling and validation module 300. The modeling and validation module 300 can include program code, which when executed by at least one processor 220 of the computer 200 can process a business process model in data store 270 produced by the modeling application 240 by mapping a role linked to an activity including one or more tasks to an object model for the tasks. The object model for the tasks can indicate, for each task, the information required to complete a corresponding task and each role, in turn, can indicate tasks able to be performed by a corresponding user assigned to the role and the information available to the corresponding user.

Thereafter, the program code of the validation module 300 can process the mapping to ensure that the tasks of an activity assigned to a role are able to be performed by a corresponding user assigned to the role, and that the corresponding user enjoys access to the information requisite to performing each task in the activity as specified by the mapped object model. To the extent that the validation fails, an operator of the validation module 300 and modeling application 240 can be alerted as to the nature of the failure. Otherwise, the operator can be informed by way of a display in the computer 200 of the successful validation.

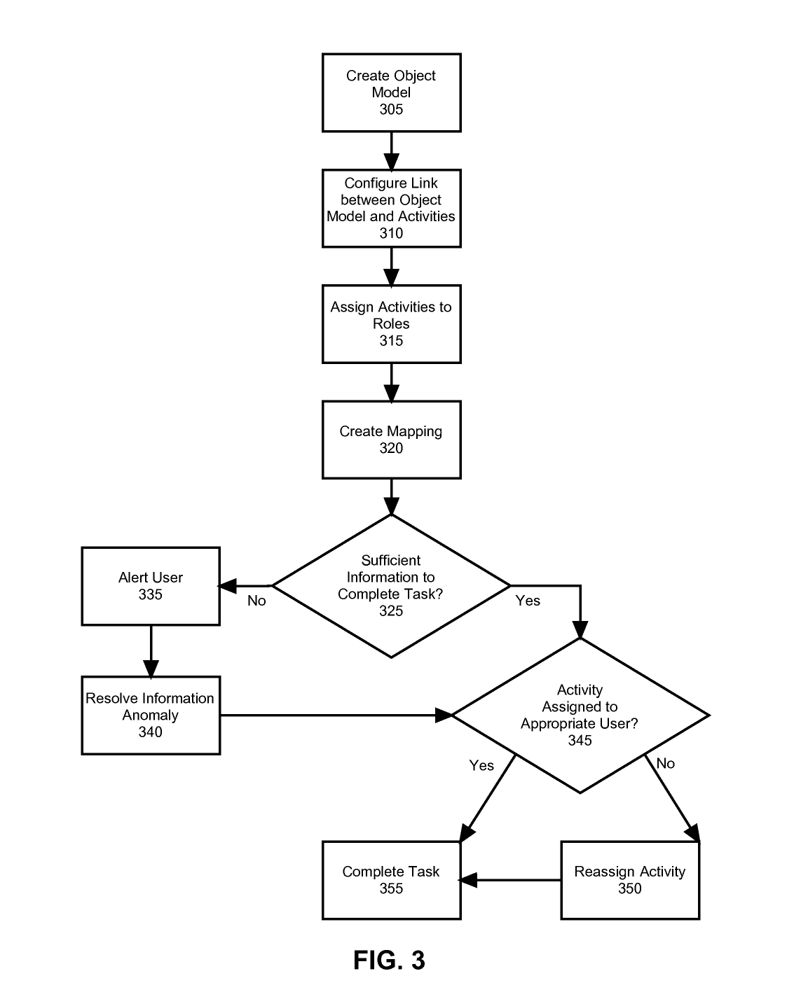

In even yet further illustration of the operation of the program code of the modeling and validation module 300, FIG. 3 is a flow chart illustrating a process for modeling and validating a business process to ensure that a user assigned to participate in an activity of the business process has the information required to complete an assigned task of the activity. Beginning in block 305, an object model is created associating different tasks with information objects requisite to performing the tasks. Links can be configured between an object model and one or more activities of a business process, as in block 310. Those links can include an association between tasks of an object model and the information required to perform those tasks, and an activity of the business process incorporating those tasks Likewise, in block 315 the activity of the business process can be assigned to a role such that an end user corresponding to the role can be specified to perform one or more tasks of the activity. Thereafter, in block 320 a mapping can be created between the linked role and the linked object model.

In decision block 325, the mapping can be processed to validate whether or not the information required to perform the tasks of the activity are available to an end user associated with the role. In decision block 325, if there is not sufficient information available, in other words, if anomalies are detected, an operator can be alerted, as shown in block 335. Otherwise, if in decision block 325 validation succeeds in respect to the accessibility of an end user of a role to information requisite to perform the tasks of the activity to which the role has been assigned, the business process can be further validated by determining whether or not an activity assigned to a role is appropriate for a user associated with the role, as shown in decision block 345. If it is determined that an activity assigned to a user is not appropriate for that user, then the activity can be reassigned to a different user, as illustrated in block 350. If the activity is assigned to an appropriate user, then the task is completed, as in block 355.

Optionally, a learning engine can identify new business processes that may contain information anomalies by detecting common objects and information use patterns. The learning engine can also be used to alert a user of potential issues in new business processes. Upon the detection of an information anomaly, the anomaly can be resolved. Further, the learning engine can be used to propose solutions to information anomalies by observing a variety of conditions and states, including but not limited to commonly used objects in context, key parameters and fields for task types, skill sets and team needed to achieve goals and to complete tasks, and information use patterns.

The information anomalies can be resolved in a number of different ways, including but not limited to creating a team and assigning a task to the team in the form of a sub-process, redesigning a role in the organization to ensure access to information and possession of required knowledge, validating the data stores of the team to ensure that at least one data store has sufficient information to complete any processes as well as any associated tasks, and redesigning processes by re-sequencing activities in process where information needed may be discovered later on in the process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1-5. (canceled)

6. A business process modeling and validation data processing system comprising:
a computer with at least one processor and memory coupled to a data store of business process models;
a modeling tool executing in the memory of the computer; and,
a validation module comprising program code enabled upon execution in the memory of the computer to link in the memory of the computer a task of an activity modeled within a business process model in the data store to a defined role specifying information accessible to end users associated with the defined role, to additionally link in the memory of the computer the task of the activity to an object model specifying information required by an end user to complete a corresponding task, to generate a mapping from the linkings, and to validate the business process by determining from the mapping whether or not an end user associated with the role can access information necessary to perform the task.

7. The system of claim 6, wherein the role additionally specifies tasks permitted to be performed by an associated end user.

8. The system of claim 7, wherein the program code of the module validates the business process by additionally determining from the mapping whether or not an end user associated with the role is permitted to perform the task of the activity.

9. The system of claim 6, wherein the program code of the module further generates an alert in a display of the computer responsive to a failure when validating the business process.

10. The system of claim 6, wherein the program code of the module further re-assigns a different user associated with a different role to perform the activity in response to a failure when validating the business process.

11. A computer program product for modeling and validating a user process, the computer program product comprising:
a computer readable storage medium having computer readable program code embodied therewith, the computer readable program code comprising:
computer readable program code for linking in memory of a computer a task of an activity modeled within a business process model to a defined role specifying information accessible to end users associated with the defined role;
computer readable program code for additionally linking in the memory of the computer the task of the activity to an object model specifying information required by an end user to complete a corresponding task;
computer readable program code for generating a mapping from the linkings; and,
computer readable program code for validating the business process by determining from the mapping whether or not an end user associated with the role can access information necessary to perform the task.

12. The computer program product of claim 11, wherein the role additionally specifies tasks permitted to be performed by an associated end user.

13. The computer program product of claim 12, wherein the computer readable program code for validating further comprises computer readable program code for determining from the mapping whether or not an end user associated with the role is permitted to perform the task of the activity.

14. The computer program product of claim 11, further comprising computer readable program code for generating an alert in a display of the computer responsive to a failure when validating the business process.

15. The computer program product of claim 11, further comprising computer readable program code for re-assigning a different user associated with a different role to perform the activity in response to a failure when validating the business process.
